(19) United States
(12) Patent Application Publication
(10) Pub. No.: US 2025/0094270 A1
(43) Pub. Date: Mar. 20, 2025

(54) INFORMATION PROCESSING SYSTEM AND NON-TRANSITORY COMPUTER-READABLE STORAGE MEDIUM

(71) Applicant: FUJIFILM Business Innovation Corp., Tokyo (JP)

(72) Inventor: Tetsuya WAKIYAMA, Kanagawa (JP)

(73) Assignee: FUJIFILM Business Innovation Corp., Tokyo (JP)

(21) Appl. No.: 18/596,581

(22) Filed: Mar. 5, 2024

(30) Foreign Application Priority Data
Sep. 20, 2023 (JP) 2023-152299

(51) Int. Cl. G06F 11/07

(52) U.S. Cl. CPC G06F 11/0793; G06F 11/0727; G06F 11/0733

(57) ABSTRACT

An information processing system includes at least one processor, wherein when a failure has occurred in a connection with a cloud service and a user has given an instruction to save data in the cloud service, the at least one processor saves the data in an apparatus other than the cloud service, and after the failure has been solved, using saving destination information indicating at least one saving destination held by the cloud service, the at least one processor performs processing for saving the data in any of the at least one saving destination of the cloud service.

### CROSS-REFERENCE TO RELATED APPLICATIONS

This application is based on and claims priority under 35 USC 119 from Japanese Patent Application No. 2023-152299 filed Sep. 20, 2023.

### BACKGROUND

### (i) Technical Field

The present invention relates to an information processing system and a non-transitory computer-readable storage medium.

### (ii) Related Art

JP2013-25387A describes an information processing apparatus including a request acquisition unit that acquires an information storage request to a service and information to be stored from an image processing apparatus, a request transmission unit that transmits the information to be stored and the storage request to a server in response to the storage request, a processing impossibility recognition unit that recognizes that communication with the server is impossible, and an alternative processing unit that stores the information to be stored in a storage medium when communication with the server is impossible.

JP2017-45099A describes a relay device including a storage unit that stores authentication information on a user who uses a cloud service and correspondence information in a case where storage of data in the cloud service fails for each user, a receiving unit that receives user information on the user, data to be stored in the cloud service, and a request for storage in the cloud service from an image processing apparatus, a transmission unit that transmits the authentication information on the user and the data to be stored in the cloud service to the cloud service in response to the request for storage in the cloud service, and a second transmission unit that transmits a correspondence method to the user with reference to correspondence information in a case where storage of data in the cloud service has failed.

### SUMMARY

In a case where a problem has occurred in the connection with a cloud service and a user gives an instruction to save data in the cloud service, a configuration is conceivable in which the data is saved in the cloud service after the problem is solved. However, when such a configuration is adopted, there is a possibility that the data is not saved in a correct saving destination of the cloud service when the saving destination information held by the cloud service is changed.

Aspects of non-limiting embodiments of the present disclosure relate to an information processing system that increases, when a failure has occurred in the connection with a cloud service and a user gives an instruction to save data in the cloud service, the possibility of data saving to a correct saving destination in the cloud service after the failure has been solved.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising at least one processor,
wherein when a failure has occurred in a connection with a cloud service and a user has given an instruction to save data in the cloud service, the at least one processor saves the data in an apparatus other than the cloud service, and after the failure has been solved, using saving destination information indicating at least one saving destination held by the cloud service, the at least one processor performs processing for saving the data in any of the at least one saving destination of the cloud service.

### BRIEF DESCRIPTION OF THE DRAWINGS

Exemplary embodiments of the present invention will be described in detail based on the following figures, wherein:

FIG. 1 is a diagram illustrating an example of an overall configuration of an image processing system according to an exemplary embodiment;

FIG. 2 is a diagram illustrating an example of a hardware configuration of an image processing apparatus according to the present exemplary embodiment;

FIG. 3 is a diagram describing a case where a failure has occurred in the connection with a cloud service selected by a user in a first exemplary embodiment;

FIG. 4 is a diagram describing the case where a failure has occurred in the connection with a cloud service selected by a user in the first exemplary embodiment;

FIG. 5 is a diagram describing a case where prior scan is selected in the first exemplary embodiment;

FIG. 6 is a diagram describing the case where prior scan is selected in the first exemplary embodiment;

FIG. 7 is a diagram describing the case where recovery from a connection failure with a cloud service is confirmed in the first exemplary embodiment;

FIG. 8 is a diagram describing the case where recovery from a connection failure with a cloud service is confirmed in the first exemplary embodiment;

FIG. 9 is a diagram describing the case where recovery from a connection failure with a cloud service is confirmed in the first exemplary embodiment;

FIG. 10 is a diagram describing the case where recovery from a connection failure with a cloud service is confirmed in the first exemplary embodiment;

FIG. 11 is a diagram describing a case where an upload deadline notification date has reached without a connection failure with a cloud service being recovered in the first exemplary embodiment;

FIG. 12 is a block diagram illustrating an example of a functional configuration of an image processing apparatus according to the first exemplary embodiment;

FIG. 13 is a flowchart illustrating an operation example of the image processing apparatus according to the first exemplary embodiment at the start of use of a cloud service;

FIG. 14 is a flowchart illustrating an operation example after an execution of prior scan of the image processing apparatus in the first exemplary embodiment;

FIG. 15 is a diagram describing a case where prior scan is selected in a second exemplary embodiment;

FIG. 16 is a diagram describing the case where prior scan is selected in the second exemplary embodiment;

FIG. 17 is a diagram describing a case where an upload deadline notification date has reached without a connection failure with a cloud service being recovered in the second exemplary embodiment;

FIG. 18 is a block diagram illustrating an example of a functional configuration of an image processing apparatus according to the second exemplary embodiment; and

FIG. 19 is a flowchart illustrating an operation example after an execution of prior scan of the image processing apparatus in the second exemplary embodiment.

### DETAILED DESCRIPTION

Hereinafter, the exemplary embodiments of the present invention will be described in detail with reference to the accompanying drawings.

### Outline of Exemplary Embodiment

The present exemplary embodiment provides an information processing system that saves, when a failure has occurred in a connection with a cloud service and a user has given an instruction to save data in the cloud service, the data in an apparatus other than the cloud service, and after the failure has been solved, using saving destination information indicating at least one saving destination held by the cloud service, performs processing for saving the data in any of the at least one saving destination of the cloud service.

The present exemplary embodiment also provide an information processing system that further performs, when the failure has not been solved by a termination time of confirming that the failure has been solved, processing for saving the data in an alternative saving destination.

Here, the “system” may be configured by a single apparatus, or may be configured by a plurality of apparatuses. In the following description, an information processing system configured by a single apparatus will be described as an example, and an image processing apparatus will be described as an example of the single apparatus.

The user may save any data in the cloud service, but hereinafter, a case where image data obtained by reading a document with an image reading unit of an image processing apparatus is saved in the cloud service will be described as an example.

Further, the image processing apparatus may save the image data in any apparatus other than the cloud service when a failure has occurred in the connection with the cloud service, but hereinafter, a case where the image data is saved in a scan data storage unit in the image processing apparatus will be described as an example.

### [Overall Configuration of Image Processing System]

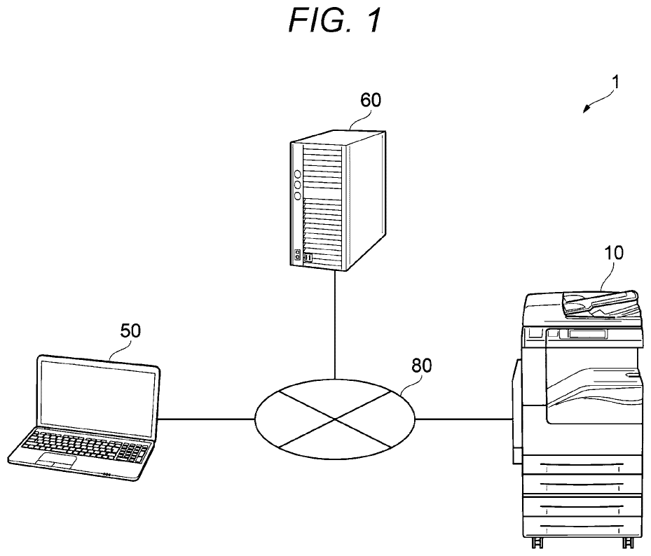

FIG. 1 is a diagram illustrating an example of an overall configuration of an image processing system 1 according to the present exemplary embodiment. As illustrated in the figure, the image processing system 1 is configured by connecting an image processing apparatus 10, a terminal apparatus 50, and a cloud server 60 via a communication line 80.

The image processing apparatus 10 is an apparatus that performs image processing such as image formation on a recording medium such as paper, image reading from a recording medium such as paper, image transmission to a public line, and image reception from a public line. The image processing apparatus 10 is a printer from the viewpoint of performing only image formation, is a copy machine from the viewpoint of performing image reading and image formation, and is a facsimile from the viewpoint of performing image reading and image transmission or image reception and image formation. Although the figure illustrates only one image processing apparatus 10, a plurality of image processing apparatuses 10 may be present.

The terminal apparatus 50 is a computer used by a user. The terminal apparatus 50 can instruct the image processing apparatus 10 to perform image processing such as image formation on a recording medium such as paper, image reading from a recording medium such as paper, image transmission to a public line, and image reception from a public line. The terminal apparatus 50 can be connected to the image processing apparatus 10 using a web browser, for example, and can be connected to the cloud server 60 from the image processing apparatus 10. As the terminal apparatus 50, for example, a desktop PC, a notebook PC, a mobile information terminal, or the like may be used. Although the figure illustrates only one terminal apparatus 50, a plurality of terminal apparatuses 50 may be present.

The cloud server 60 is a server computer that provides a cloud service of another company different from the own company that operates the image processing apparatus 10. An addition-type application of the image processing apparatus 10 causes the image processing apparatus 10 and a cloud service of another company to cooperate with each other via the cloud of the own company. As such a cloud service of another company, there are a storage service mainly for saving data and a workflow cooperation service such as business flow, Customer Relationship Management (CRM), and Sales Force Automation (SFA, business support). Here, the storage service is particularly assumed. Specifically, a service is assumed in which a user saves image data (hereinafter, also referred to as “scan data”) obtained by image reading (hereinafter, also referred to as “scanning”) with an image reading unit of the image processing apparatus 10. As the cloud server 60, for example, a general-purpose personal computer may be used. Although only one cloud server 60 is illustrated in the figure, a plurality of cloud servers 60 may be present.

The communication line 80 is a line used for information communication between the image processing apparatus 10 and the terminal apparatus 50 and between the image processing apparatus 10 and the cloud server 60. As the communication line 80, for example, the Internet may be used.

### [Hardware Configuration of Image Processing Apparatus]

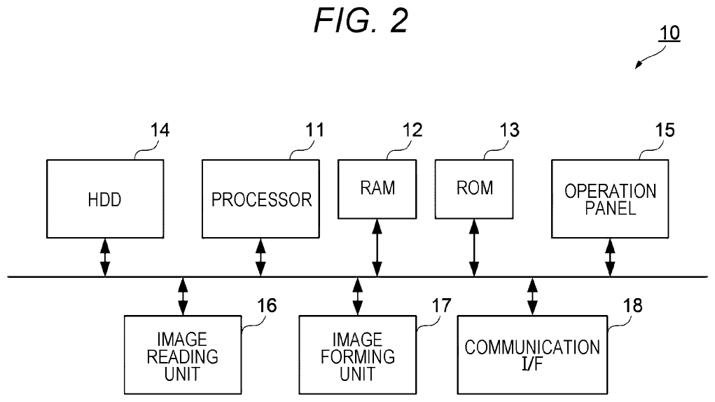

FIG. 2 is a diagram illustrating an example of a hardware configuration of the image processing apparatus 10 according to the present exemplary embodiment. As illustrated in the figure, the image processing apparatus 10 includes a processor 11, a random access memory (RAM) 12, a read only memory (ROM) 13, a hard disk drive (HDD) 14, an operation panel 15, an image reading unit 16, an image forming unit 17, and a communication interface (I/F) 18.

The processor 11 realizes each function described later by loading various programs stored in the ROM 13 or the like into the RAM 12 and executing the programs.

The RAM 12 is a memory used as a working memory or the like of the processor 11.

The ROM 13 is a memory that stores various programs to be executed by the processor 11.

The HDD 14 is, for example, a magnetic disk device that stores image date read by the image reading unit 16, image date used for image formation in the image forming unit 17, and the like.

The operation panel 15 is, for example, a touch panel that displays various kinds of information and receives operation input from the user. Here, the operation panel 15 includes a display on which various kinds of information are displayed and a position detection sheet for detecting the position indicated by an indication method such as a finger or a stylus pen. Alternatively, a display and a keyboard may be used instead of the touch panel.

The image reading unit 16 reads an image recorded on a recording medium such as paper. Here, the image reading unit 16 is, for example, a scanner, and a CCD type in which reflected light of light emitted from a light source to a document is reduced by a lens and received by charge coupled devices (CCD) or a CIS type in which reflected light of light sequentially emitted from LED light sources to a document is received by a contact image sensor (CIS) may be used.

The image forming unit 17 forms an image on a recording medium such as paper. Here, the image forming unit 17 is, for example, a printer, and an electrophotographic method in which a toner adhered to a photoreceptor is transferred onto a recording medium to form an image, or an inkjet method in which ink is ejected onto a recording medium to form an image may be used.

The communication I/F 18 transmits and receives various kinds of information to and from another apparatus, for example, the terminal apparatus 50 or the cloud server 60 via the communication line 80.

### [Problems in Image Processing Apparatus]

There are cases where the cloud service is stopped due to maintenance, an abnormal state, or the like, and the image processing apparatus 10 cannot be connected to the cloud service when starting processing.

In such a case, in the related art, a common method is a method in which, after waiting for the resumption of the connection with the cloud service, the user goes to the image processing apparatus 10 again and performs the setting related to the cloud service, the execution of the scan, and uploading.

However, in such a method, for example, it takes time and effort for the user to continuously monitor the operation state of the cloud service, confirm the operation, go to the image processing apparatus 10, acquire the latest setting related to the upload again, and execute the processing again. In addition, for example, in a workflow that handles contract processing, the processing needs to be executed by the deadline, but when the connection with the cloud service is not resumed, there is a possibility that the processing is not able to be executed by the deadline.

### First Exemplary Embodiment

### (Overview)

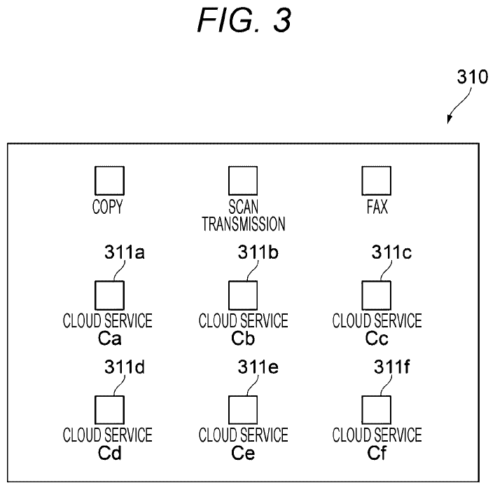

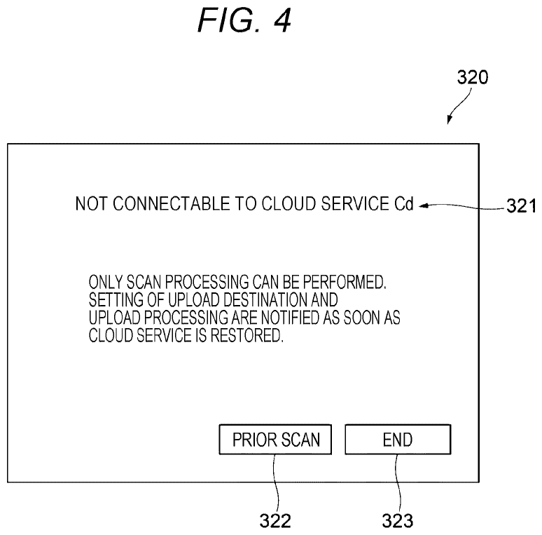

FIGS. 3 and 4 are diagrams describing a case where a failure has occurred in the connection with a cloud service selected by a user in a first exemplary embodiment.

First, the image processing apparatus 10 displays a cloud service selection screen 310 illustrated in FIG. 3. The cloud service selection screen 310 includes icons 311a to 311f for selecting cloud services Ca to Cf. When the user has selected an icon indicating a cloud service to use on the cloud service selection screen 310, the image processing apparatus 10 performs any of the following operations depending on whether the cloud service has been correctly connected.

When the cloud service has been correctly connected, the image processing apparatus 10 transitions to the next setting screen. Here, as such a setting screen, there is an upload setting screen for performing settings related to uploading of scan data. Details of the upload setting screen will be described later.

On the other hand, when the cloud service has not been correctly connected, that is, when the connection to the cloud service has failed, the image processing apparatus 10 displays a connection unavailability notification screen 320 illustrated in FIG. 4. The connection unavailability notification screen 320 includes a message 321, a prior scan button 322, and an end button 323. The message 321 indicates that connection to the cloud service is not possible. Here, it is assumed that an icon 311d is selected on the cloud service selection screen 310 of FIG. 3, and the message 321 indicates that connection to the cloud service Cd is not possible. The prior scan button 322 is a button for giving an instruction to perform prior scan for performing only scanning in advance. The end button 323 is a button for giving an instruction to end as it is. With these buttons, the user selects whether to perform the prior scan or to end as it is.

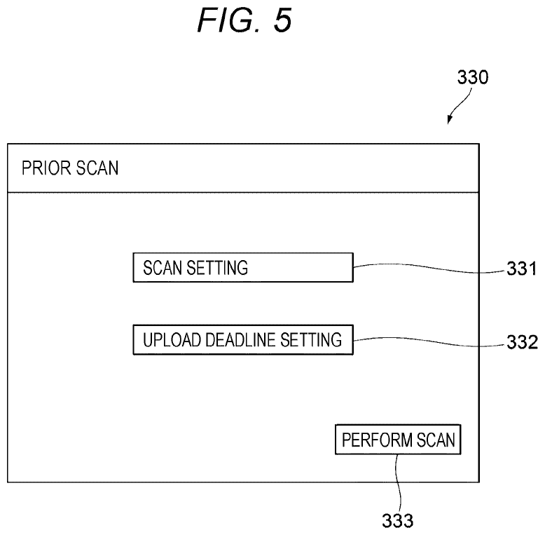

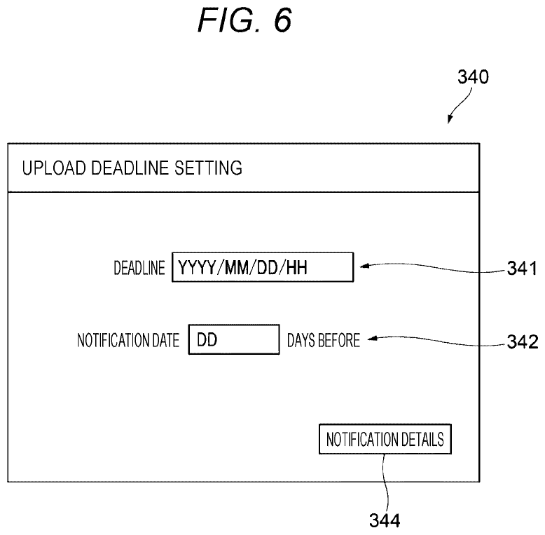

FIGS. 5 and 6 are diagrams describing a case where prior scan has been selected in the first exemplary embodiment.

When the prior scan button 322 has been pressed on the connection unavailability notification screen 320 of FIG. 4, the image processing apparatus 10 displays a prior scan screen 330 illustrated in FIG. 5. The prior scan screen 330 includes a scan setting button 331, an upload deadline setting button 332, and a scan execution button 333. The user sets parameters for scanning, a file name of scan data, and the like by pressing the scan setting button 331. In addition, the user executes scanning by pressing the scan execution button 333.

When the upload deadline setting button 332 has been pressed on the prior scan screen 330 in FIG. 5, the image processing apparatus 10 displays an upload deadline setting screen 340 illustrated in FIG. 6. The upload deadline setting screen 340 includes a deadline input field 341, a notification date input field 342, and a notification details button 344. The user sets the upload deadline of the scan data in the deadline input field 341. In addition, the user sets, separately from the upload deadline, in the notification date input field 342, an upload deadline notification date on which the user is notified that the upload deadline approaching before the upload deadline. In addition to the date, a time may be set as the upload deadline notification date. Further, the user sets an E-mail address of a notification destination to indicate that the upload deadline is approaching, whether to make a reminder that the upload deadline is approaching, and the like by pressing the notification details button 344.

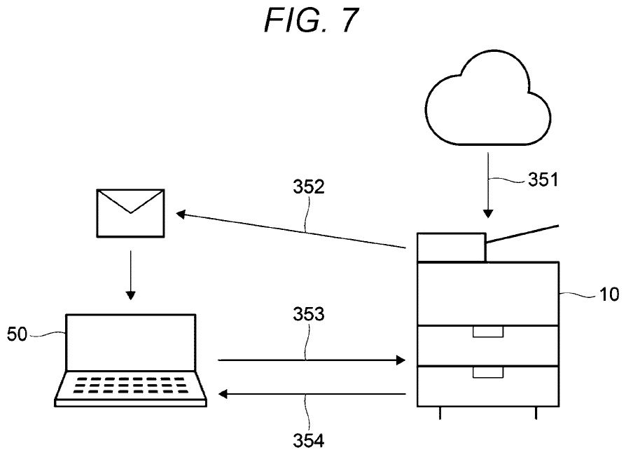

FIGS. 7 to 10 are diagrams describing a case where recovery from a connection failure with a cloud service is confirmed in the first exemplary embodiment.

When the recovery from the connection failure with the cloud service is confirmed, the image processing apparatus 10 first acquires upload setting information from the cloud service as indicated by an arrow 351 in FIG. 7. Here, the upload setting information is setting information related to uploading, and includes, for example, setting information of an upload destination. Next, the image processing apparatus 10 notifies the user that the connection with the cloud service has been restored as indicated by an arrow 352 in FIG. 7. This notification may be provided by, for example, E-mail, and this E-mail may include a uniform resource locator (URL) of the upload setting screen for making settings related to uploading. The user then accesses the URL contained in the notification as indicated by arrow 353 in FIG. 7. This causes the image processing apparatus 10 to display the upload setting screen on the terminal apparatus 50 as indicated by an arrow 354 in FIG. 7.

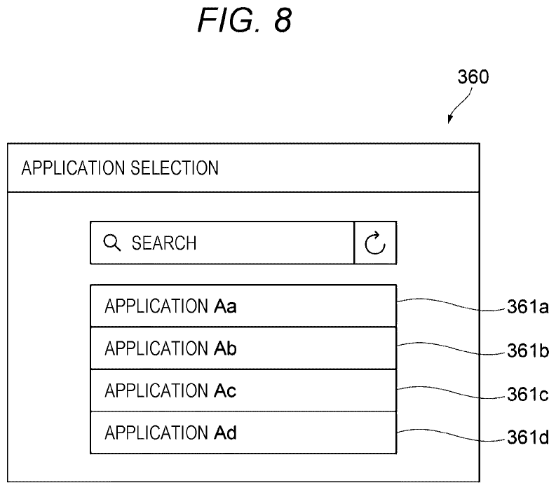

Specifically, the image processing apparatus 10 displays an application selection screen 360 illustrated in FIG. 8 as a first upload setting screen on the terminal apparatus 50. The application selection screen 360 includes buttons 361a to 361d for selecting applications Aa to Ad. Here, the application is, for example, a type of a case to be managed.

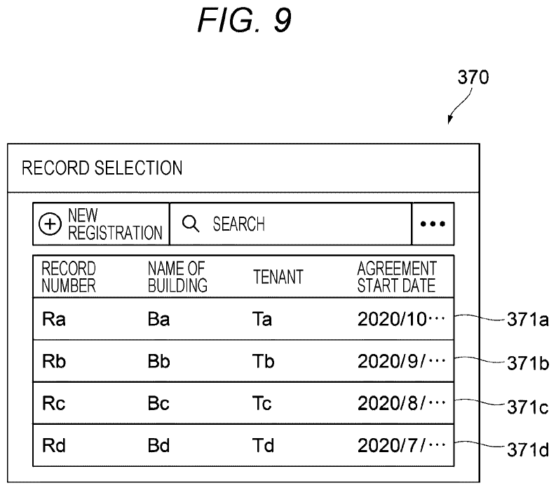

When any of the buttons 361a to 361d has been pressed on the application selection screen 360 in FIG. 8, the image processing apparatus 10 displays, as a second upload setting screen, a record selection screen 370 illustrated in FIG. 9 on the terminal apparatus 50. The record selection screen 370 includes buttons 371a to 371d for selecting records such as record numbers Ra to Rd. Here, the record is, for example, a unit of a case for each type of case.

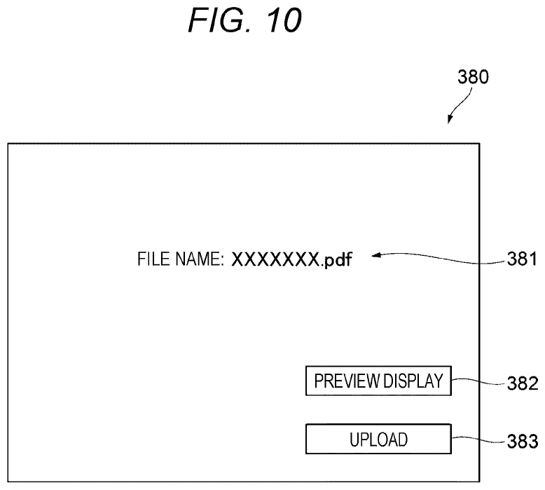

When any of the buttons 371a to 371d on the record selection screen 370 in FIG. 9 has been pressed, the image processing apparatus 10 displays an upload screen 380 illustrated in FIG. 10 on the terminal apparatus 50. The upload screen 380 includes a file name display field 381, a preview display button 382, and an upload button 383. The image processing apparatus 10 displays the file name of the scan data subjected to prior scan in the file name display field 381. In addition, the user confirms a thumbnail image of the scan data by pressing the preview display button 382. Further, when the user has pressed the upload button 383, the image processing apparatus 10 uploads the scan data. For example, the image processing apparatus 10 uploads the scan data to the record selected on the record selection screen 370 as an upload destination, among the records managed by the application selected on the application selection screen 360.

Here, the application selection screen 360, the record selection screen 370, and the upload screen 380 are web user interfaces (UI) for operating the image processing apparatus 10 via the Internet on the web browser of the terminal apparatus 50, but the present invention is not limited to this configuration. The application selection screen 360, the record selection screen 370, and the upload screen 380 may be UIs displayed on the operation panel 15 of the image processing apparatus 10.

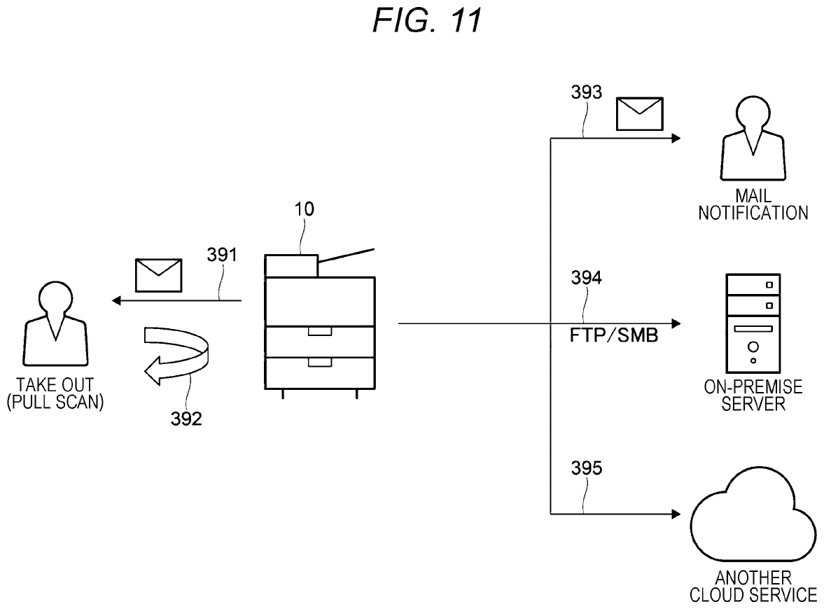

FIG. 11 is a diagram describing a case where the upload deadline notification date has reached without the connection failure with the cloud service being recovered in the first exemplary embodiment.

When the upload deadline notification date has reached without the connection failure with the cloud service being recovered, the image processing apparatus 10 notifies the user that the upload deadline is approaching, as indicated by an arrow 391 in FIG. 11. This notification may also be provided by, for example, E-mail, and this E-mail may include a description on alternative methods for handling the scan data obtained in the prior scan.

Here, as indicated by an arrow 392 in FIG. 11, the alternative method may be that the user takes out the scan data from the image processing apparatus 10 and saves the scan data in the terminal apparatus 50 (pull scanning). The pull scanning refers to taking out scan data saved in the image processing apparatus 10 by an operation of the terminal apparatus 50.

As indicated by an arrow 393 in FIG. 11, the alternative method may also be that the user instructs the image processing apparatus 10 to transmit the scan data by E-mail to a mail address selected from an address book or a newly input mail address.

Further, as indicated by an arrow 394 in FIG. 11, the alternative method may be that the user instructs the image processing apparatus 10 to transmit the scan data to an address of an on-premise server selected from the address book or an address of an on-premise server newly input by file transfer protocol (FTP) or a server message block (SMB).

Furthermore, as indicated by an arrow 395 in FIG. 11, the alternative method may be that the user instructs the image processing apparatus 10 to transmit the scan data to an address of another cloud service.

### (Functional Configuration of Image Processing Apparatus)

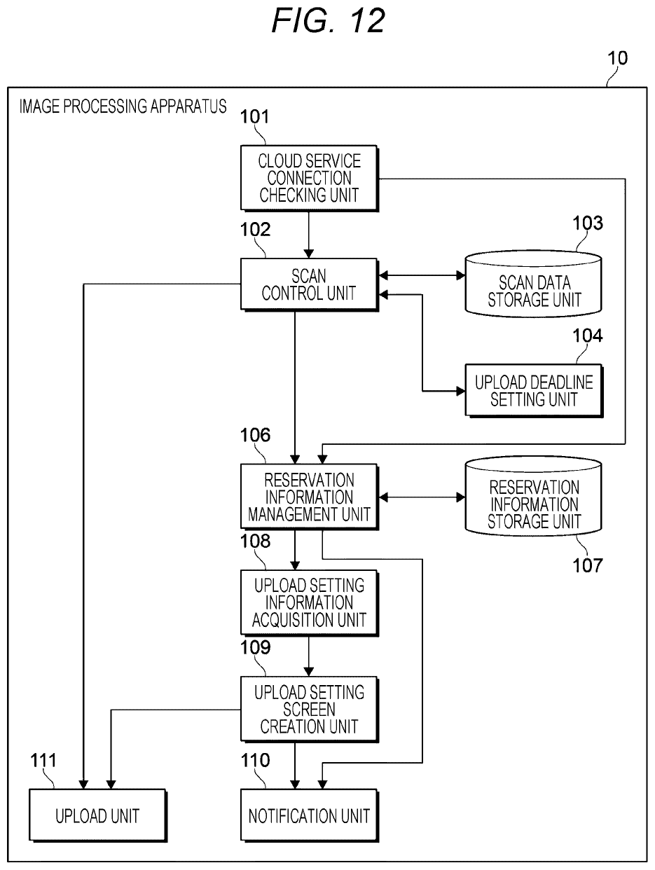

FIG. 12 is a block diagram illustrating an example of a functional configuration of the image processing apparatus 10 according to the first exemplary embodiment. As illustrated in the figure, the image processing apparatus 10 according to the first exemplary embodiment includes a cloud service connection checking unit 101, a scan control unit 102, a scan data storage unit 103, and an upload deadline setting unit 104. In addition, the image processing apparatus 10 according to the first exemplary embodiment includes a reservation information management unit 106 and a reservation information storage unit 107. Further, the image processing apparatus 10 according to the first exemplary embodiment includes an upload setting information acquisition unit 108, an upload setting screen creation unit 109, a notification unit 110, and an upload unit 111.

The cloud service connection checking unit 101 periodically checks whether connection to the cloud service is possible at the start of use of the cloud service or after an execution of the prior scan. In a broader sense, this corresponds to periodically checking whether a failure has occurred in the connection with the cloud service. In addition, when the cloud service connection checking unit 101 confirms that connection with the cloud service is not possible, the cloud service connection checking unit 101 displays the fact on the operation panel 15.

When the cloud service connection checking unit 101 has confirmed that connection to the cloud service is possible at the start of use of the cloud service, the scan control unit 102 instructs to scan a document. Then, the scan control unit 102 transfers the scan data obtained by the scan to the upload unit 111.

In addition, when the availability of connection with the cloud service has not been confirmed by the cloud service connection checking unit 101 at the start of use of the cloud service, the scan control unit 102 instructs to perform prior scan on the document. Then, the scan control unit 102 stores the scan data obtained by the prior scan in the scan data storage unit 103. At that time, the scan control unit 102 stores the scan data in the scan data storage unit 103 in association with user information, as described later. Here, the user information may be identification information of the user. In the present exemplary embodiment, when the user gives an instruction to save the data in the cloud service and a failure has occurred in the connection with the cloud service, this processing of the scan control unit 102 is performed as an example of saving the data in an apparatus other than the cloud service. In addition, in the present exemplary embodiment, when a failure has occurred and the user gives an instruction to save the data in the cloud service, this processing in the scan control unit 102 is performed as an example of saving data in association with the identification information of the user. Further, in the present exemplary embodiment, when a failure has occurred and the user issues an instruction to save, in the cloud service, image data obtained by reading a document with the image reading unit as the data, this processing in the scan control unit 102 is performed as an example of instructing the user to read the document with the image reading unit. Furthermore, in the present exemplary embodiment, when a failure has occurred and the user has issued an instruction to save, in the cloud service, image data obtained by reading a document with the image reading unit as the data, this processing in the scan control unit 102 is performed as an example of saving, in a device other than the cloud service, the image data obtained by the user reading the document with the image reading unit.

When the availability of connection with the cloud service has not been confirmed by the cloud service connection checking unit 101 at the start of use of the cloud service, the scan data storage unit 103 stores the scan data obtained in the prior scan.

When the availability of connection with the cloud service has not been confirmed by the cloud service connection checking unit 101 at the start of use of the cloud service, the upload deadline setting unit 104 accepts input of an upload deadline and an upload deadline notification date. Then, the upload deadline setting unit 104 sets the accepted upload deadline and upload deadline notification date. In the present exemplary embodiment, when a failure has occurred and the user issues an instruction to save data in the cloud service, the processing inf the upload deadline setting unit 104 is performed as an example of setting a termination time.

When the availability of connection with the cloud service has not been confirmed by the cloud service connection checking unit 101 at the start of use of the cloud service, the reservation information management unit 106 creates reservation information. Here, the reservation information is information in which the scan data stored in the scan data storage unit 103, the upload deadline set by the upload deadline setting unit 104, and the user information are associated with each other. Then, the reservation information management unit 106 stores the reservation information in the reservation information storage unit 107.

In addition, the reservation information management unit 106 reads the reservation information from the reservation information storage unit 107 after an execution of the prior scan. Then, when the cloud service connection checking unit 101 has confirmed that connection with the cloud service is possible, the reservation information management unit 106 extracts the user information from the reservation information. When the availability of connection with the cloud service has not been confirmed by the cloud service connection checking unit 101 at the start of use of the cloud service, the reservation information management unit 106 takes out the upload deadline notification date from the reservation information.

When the availability of connection with the cloud service has not been confirmed by the cloud service connection checking unit 101 at the start of use of the cloud service, the reservation information storage unit 107 stores the reservation information created by the reservation information management unit 106. Here, the reservation information is, as described above, information in which the scan data stored in the scan data storage unit 103, the upload deadline set by the upload deadline setting unit 104, and the user information are associated with each other.

The upload setting information acquisition unit 108 accesses a cloud service and acquires upload setting information from the cloud service. Here, the upload setting information is setting information related to uploading, and includes, for example, setting information related to an upload destination. After an execution of the prior scan, when the cloud service connection checking unit 101 has confirmed that connection with the cloud service is possible, the upload setting information acquisition unit 108 accesses the cloud service using the user information extracted by the reservation information management unit 106. In the present exemplary embodiment, the upload setting information is used as an example of saving destination information indicating a saving destination held by the cloud service. In the present exemplary embodiment, the processing in the upload setting information acquisition unit 108 is performed as an example of acquiring the saving destination information by accessing the cloud service using the identification information after the failure has been solved.

The upload setting screen creation unit 109 creates an upload setting screen based on the upload setting information acquired by the upload setting information acquisition unit 108. Here, the upload setting screen is a screen for performing setting related to uploading, and the setting related to uploading includes, for example, setting of an upload destination.

When the cloud service connection checking unit 101 has confirmed that connection with the cloud service is possible after an execution of the prior scan, the notification unit 110 notifies the user of a URL for accessing the upload setting information, for example, by E-mail. For example, the notification unit 110 may notify the user of the URL of the upload setting screen created by the upload setting screen creation unit 109. In the present exemplary embodiment, this processing in the notification unit 110 is performed as an example of performing processing for saving data in any of the saving destinations of the cloud service using the saving destination information after the failure has been solved. In the present exemplary embodiment, this processing in the notification unit 110 is performed as an example of notifying the user of the saving destination information after the failure has been solved. Further, in the present exemplary embodiment, this processing in the notification unit 110 is performed as an example of performing processing for saving the image data in any of the saving destinations of the cloud service using the saving destination information after the failure has been solved.

In addition, the notification unit 110 notifies the user that the upload deadline is approaching when the upload deadline notification date has reached without availability of connection with the cloud service being confirmed after the execution of the prior scan. This notification may be made by E-mail, for example. This E-mail may include a description on an alternative method for handling the scan data obtained in the prior scan. Here, the alternative method includes, for example, taking out data from the image processing apparatus 10 (pull scanning), transmission to a destination registered in the image processing apparatus 10 or a new destination by E-mail, FTP, SMB, or the like, and transfer to another cloud service. In the present exemplary embodiment, this processing in the notification unit 110 is performed as an example of performing processing for saving data in an alternative saving destination when the failure has not been solved by the termination time of confirming that the failure has been solved. In addition, in the present exemplary embodiment, this processing in the notification unit 110 is performed as an example of notifying the user of an operation that the user can perform to save the data in an alternative saving destination when the failure has not been solved by the termination time of that confirming the failure has been solved. Further, in the present exemplary embodiment, this processing in the notification unit 110 is performed as an example of performing processing for saving the image data in an alternative saving destination when the failure has not been solved by the time at which the user is notified that the saving deadline of the image data set as the termination time is approaching.

The upload unit 111 uploads the scan data obtained by the scanning with the scan control unit 102 to the cloud service. It is assumed that, when it has been confirmed by the cloud service connection checking unit 101 that connection with the cloud service is possible after the execution of the prior scan, the user accesses the notified URL, sets an upload destination, and instructs upload. Then, the upload unit 111 takes out the scan data from the scan data storage unit 103 and uploads the scan data to the set upload destination. In the present exemplary embodiment, this processing in the upload unit 111 is performed as an example of performing processing for saving data in any of the saving destinations of the cloud service using the saving destination information after the failure has been solved. In the present exemplary embodiment, the processing in the upload unit 111 is performed as an example of saving the data in a saving destination designated by the user among the saving destinations indicated by the saving destination information after the failure has been solved. Further, in the present exemplary embodiment, this processing in the upload unit 111 is performed as an example of performing processing for saving image data in any of the saving destinations of the cloud service using the saving destination information after the failure has been solved.

### (Operation of Image Processing Apparatus)

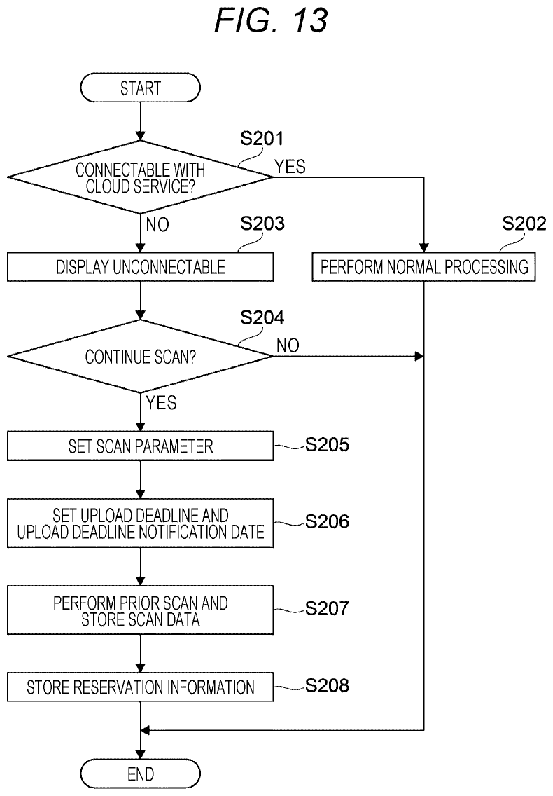

FIG. 13 is a flowchart illustrating an operation example of the image processing apparatus 10 according to the first exemplary embodiment at the start of use of a cloud service.

In the image processing apparatus 10, first, the cloud service connection checking unit 101 checks whether connection with the cloud service is possible (step 201).

When it has been confirmed in step 201 that connection with the cloud service is possible, the image processing apparatus 10 performs normal processing (step 202). Specifically, the scan control unit 102 instructs to perform scanning on the spot. Next, the upload setting information acquisition unit 108 acquires the upload setting information from the cloud service, and the upload unit 111 uploads the scan data acquired by scanning to the cloud service using the upload setting information.

On the other hand, when it has not been confirmed in step 201 that connection with the cloud service is possible, the cloud service connection checking unit 101 displays, on the operation panel 15, a message that connection with the cloud service is not possible (step 203). Specifically, the cloud service connection checking unit 101 displays the connection unavailability notification screen 320 of FIG. 4 on the operation panel 15.

Next, the scan control unit 102 determines whether the user continues scanning (step 204). Specifically, the scan control unit 102 determines which of the prior scan button 322 and the end button 323 has been pressed on the connection unavailability notification screen 320 of FIG. 4.

When it has been determined in step 204 that the user does not continue scanning, the scan control unit 102 ends the processing. Specifically, when the end button 323 has been pressed on the connection unavailability notification screen 320 of FIG. 4, the scan control unit 102 ends the processing without performing any further processing.

On the other hand, when it has been determined in step 204 that the user continues scanning, the scan control unit 102 sets scan parameters (step 205). Specifically, the scan control unit 102 sets scan parameters input by pressing the scan setting button 331 on the prior scan screen 330 in FIG. 5.

Next, the upload deadline setting unit 104 sets an upload deadline and an upload deadline notification date (step 206). Specifically, when the upload deadline setting button 332 has been pressed on the prior scan screen 330 in FIG. 5, the upload deadline setting unit 104 displays the upload deadline setting screen 340 in FIG. 6. Then, the upload deadline setting unit 104 sets the upload deadline and the upload deadline notification date input on the upload deadline setting screen 340 in FIG. 6.

Next, the scan control unit 102 performs the prior scan using the scan parameters set in step 205, and stores the scan data obtained by the prior scan in the scan data storage unit 103 (step 207). Specifically, when the scan execution button 333 has been pressed on the prior scan screen 330 of FIG. 5, the scan control unit 102 performs the prior scan and stores the scan data in the scan data storage unit 103.

Thereafter, the reservation information management unit 106 stores, in the reservation information storage unit 107, reservation information indicating a reservation for uploading of the scan data when connection with the cloud service is enabled (step 208). Here, the reservation information is information in which the upload deadline and the upload deadline notification date set in step 206, the scan data stored in the scan data storage unit 103 in step 207, and the user information are associated with each other.

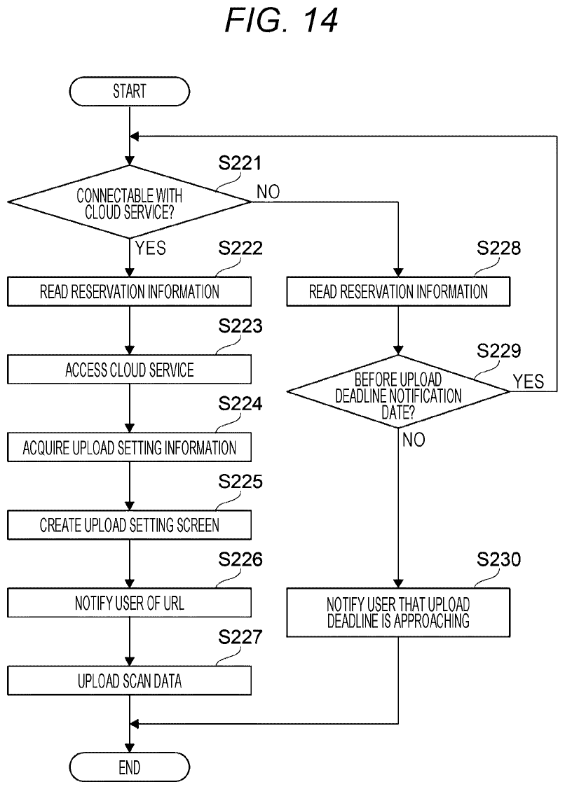

FIG. 14 is a flowchart illustrating an operation example of the image processing apparatus 10 according to the first exemplary embodiment after an execution of the prior scan.

In the image processing apparatus 10, first, the cloud service connection checking unit 101 checks whether connection with the cloud service is possible (step 221).

When it has been confirmed in step 221 that connection with the cloud service is possible, the reservation information management unit 106 reads reservation information from the reservation information storage unit 107 (step 222).

Next, the upload setting information acquisition unit 108 accesses the cloud service using the user information included in the reservation information read in step 222 (step 223). Next, the upload setting information acquisition unit 108 acquires upload setting information from the cloud service (step 224).

Next, the upload setting screen creation unit 109 creates an upload setting screen based on the upload setting information acquired in step 224 (step 225).

Next, the notification unit 110 notifies the user of the URL of the upload setting screen created in step 225, for example, by E-mail (step 226).

Thereafter, it is assumed that the user accesses the notified URL and instructs to upload the scan data. Next, the upload unit 111 uploads the scan data stored in the scan data storage unit 103 in step 207 to the cloud service (step 227).

On the other hand, when it has not been confirmed in step 221 that the connection with the cloud service is possible, the reservation information management unit 106 reads the reservation information from the reservation information storage unit 107 (step 228). Next, the reservation information management unit 106 determines whether the current date is earlier than the upload deadline notification date included in the reservation information read in step 228 (step 229).

When it has been determined in step 229 that the current date is earlier than the upload deadline notification date, the reservation information management unit 106 returns the processing to step 221.

On the other hand, when it has been determined in step 229 that the current date is not earlier than the upload deadline notification date, the notification unit 110 notifies the user that the upload deadline is approaching, for example, by E-mail (step 230). This E-mail may include a description on an alternative method with respect to uploading of the scan data to the cloud service selected by the user.

### Second Exemplary Embodiment

### (Overview)

The case where a failure has occurred in the connection with the cloud service selected by the user in a second exemplary embodiment is the same as the case where a failure has occurred in the connection with the cloud service selected by the user in the first exemplary embodiment, and thus the description thereof will be omitted.

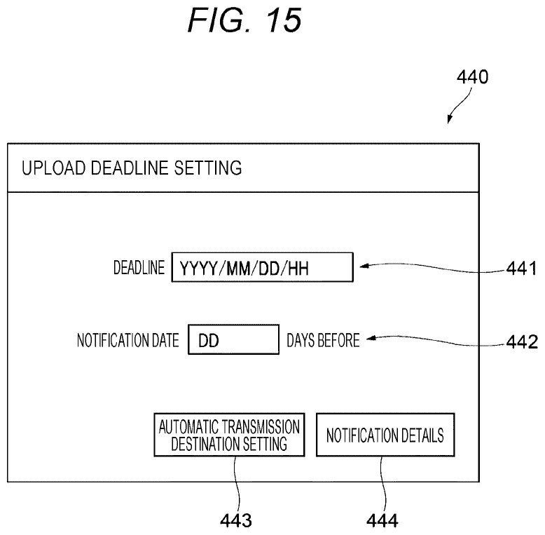

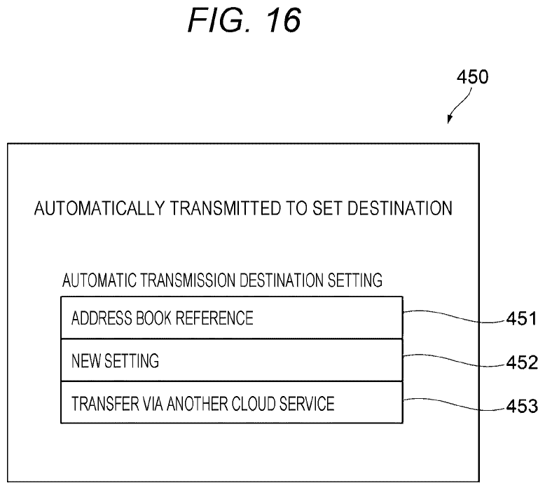

FIGS. 15 and 16 are diagrams for describing a case where prior scan is selected in the second exemplary embodiment. Also when prior scan is selected in the second exemplary embodiment, the prior scan screen 330 is first displayed in the same manner as in the case where prior scan is selected in the first exemplary embodiment, and this has been described with reference to FIG. 5, and therefore, description thereof is omitted herein.

When the upload deadline setting button 332 has been pressed on the prior scan screen 330 in FIG. 5, the image processing apparatus 10 displays an upload deadline setting screen 440 illustrated in FIG. 15. The upload deadline setting screen 440 includes a deadline input field 441, a notification date input field 442, an automatic transmission destination setting button 443, and a notification details button 444. The user sets the upload deadline of the scan data in the deadline input field 441. In addition, the user sets, separately from the upload deadline, in the notification date input field 442, an upload deadline notification date on which the user is notified that the upload deadline approaching before the upload deadline. Further, the user sets an E-mail address of a notification destination to indicate that the upload deadline is approaching, whether to make a reminder that the upload deadline is approaching, and the like by pressing the notification details button 444.

When the automatic transmission destination setting button 443 has been pressed on the upload deadline setting screen 440 in FIG. 15, the image processing apparatus 10 displays an automatic transmission destination setting screen 450 illustrated in FIG. 16. The automatic transmission destination setting screen 450 includes an address book reference button 451, a new setting button 452, and another cloud service transfer button 453. With these buttons, the user sets the scan data obtained by the prior scan to be automatically transmitted to another transmission destination on the upload deadline notification date.

The case where the recovery from the connection failure with the cloud service is confirmed in the second exemplary embodiment is the same as the case where the recovery from the connection failure with the cloud service is confirmed in the first exemplary embodiment, and thus the description thereof will be omitted.

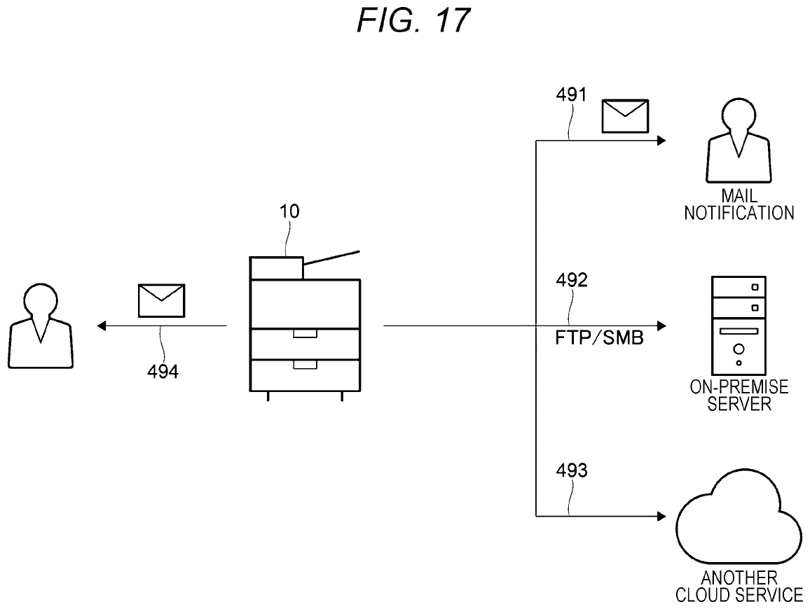

FIG. 17 is a diagram describing a case where the upload deadline notification date has reached without the connection failure with the cloud service being recovered in the second exemplary embodiment.

When the upload deadline notification date has reached without the connection failure with the cloud service being recovered, the image processing apparatus 10 first transmits the scan data obtained by the prior scan to the automatic transmission destination set on the automatic transmission destination setting screen 450 of FIG. 16.

For example, it is assumed that the user sets a mail address selected from the address book by pressing the address book reference button 451 or a mail address newly input by pressing the new setting button 452 on the automatic transmission destination setting screen 450 in FIG. 16. Then, the image processing apparatus 10 transmits the scan data to the mail address by E-mail as indicated by an arrow 491 in FIG. 17.

in addition, it is assumed that the user sets an address of an on-premise server selected from the address book by pressing the address book reference button 451 or an address of an on-premise server newly input by pressing the new setting button 452 on the automatic transmission destination setting screen 450 in FIG. 16. Then, as indicated by an arrow 492 in FIG. 17, the image processing apparatus 10 transmits the scan data to the address of the on-premise server by FTP or SMB.

Further, it is assumed that the user presses the another cloud service transfer button 453 on the automatic transmission destination setting screen 450 in FIG. 16 to set an address of another cloud service. Then, as indicated by an arrow 493 in FIG. 17, the image processing apparatus 10 transmits the scan data to the address of the other cloud service.

Next, as indicated by an arrow 494 in FIG. 17, the image processing apparatus 10 notifies the user that transmission of the scan data has been completed.

### (Functional Configuration of Image Processing Apparatus)

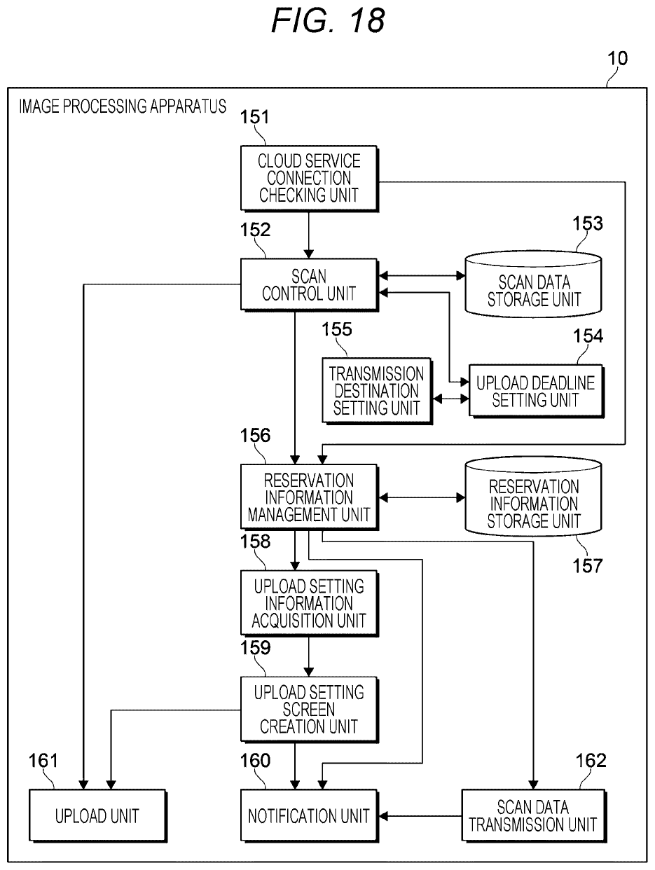

FIG. 18 is a block diagram illustrating an example of a functional configuration of the image processing apparatus 10 according to the second exemplary embodiment. As illustrated in the figure, the image processing apparatus 10 according to the second exemplary embodiment includes a cloud service connection checking unit 151, a scan control unit 152, a scan data storage unit 153, an upload deadline setting unit 154, and a transmission destination setting unit 155. In addition, the image processing apparatus 10 according to the second exemplary embodiment includes a reservation information management unit 156 and a reservation information storage unit 157. Further, the image processing apparatus 10 according to the second exemplary embodiment includes an upload setting information acquisition unit 158, an upload setting screen creation unit 159, a notification unit 160, an upload unit 161, and a scan data transmission unit 162.

The cloud service connection checking unit 151, the scan control unit 152, the scan data storage unit 153, and the upload deadline setting unit 154 are the same as the cloud service connection checking unit 101, the scan control unit 102, the scan data storage unit 103, and the upload deadline setting unit 104 in the first exemplary embodiment, and thus description thereof will be omitted.

The transmission destination setting unit 155 accepts input of an automatic transmission destination of the scan data when the upload deadline notification date has reached without availability of connection with the cloud service being confirmed after the execution of the prior scan. Then, the transmission destination setting unit 155 sets the accepted automatic transmission destination.

When the availability of connection with the cloud service has not been confirmed by the cloud service connection checking unit 151 at the start of use of the cloud service, the reservation information management unit 156 creates reservation information. Here, the reservation information is information in which the scan data stored in the scan data storage unit 153, the upload deadline set by the upload deadline setting unit 154, the automatic transmission destination set by the transmission destination setting unit 155, and the user information are associated with each other. Then, the reservation information management unit 156 stores the reservation information in the reservation information storage unit 157.

In addition, the reservation information management unit 156 reads the reservation information from the reservation information storage unit 157 after the execution of the prior scan. Then, when the cloud service connection checking unit 151 has confirmed that connection with the cloud service is possible, the reservation information management unit 156 extracts the user information from the reservation information. When the availability of connection with the cloud service has not been confirmed by the cloud service connection checking unit 151 at the start of use of the cloud service, the reservation information management unit 156 extracts the upload deadline notification date from the reservation information. Then, when the current date is after the upload deadline notification date, the reservation information management unit 156 determines whether the reservation information includes an automatic transmission destination.

When the availability of connection with the cloud service has not been confirmed by the cloud service connection checking unit 151 at the start of use of the cloud service, the reservation information storage unit 157 stores the reservation information created by the reservation information management unit 156. Here, the reservation information is, as described above, information in which the scan data stored in the scan data storage unit 153, the upload deadline set by the upload deadline setting unit 154, the automatic transmission destination set by the transmission destination setting unit 155, and the user information are associated with each other.

The upload setting information acquisition unit 158 and the upload setting screen creation unit 159 are the same as the upload setting information acquisition unit 108 and the upload setting screen creation unit 109 in the first exemplary embodiment, and thus the description thereof will be omitted.

When the cloud service connection checking unit 151 has confirmed that connection with the cloud service is possible after the execution of the prior scan, the notification unit 160 notifies the user of a URL for accessing the upload setting information, for example, by E-mail. For example, the notification unit 160 may notify the user of the URL of the upload setting screen created by the upload setting screen creation unit 159. In the present exemplary embodiment, this processing in the notification unit 160 is performed as an example of performing processing for saving data in any of the saving destinations of the cloud service using the saving destination information after the failure has been solved. In the present exemplary embodiment, this processing of the notification unit 160 is performed as an example of notifying the user of the saving destination information after the failure has been solved.

In addition, the notification unit 160 notifies the user of the completion of the transmission of the scan data when the upload deadline notification date has reached without availability of connection with the cloud service being confirmed after the execution of the prior scan. Here, the completion of transmission of scan data is information that the scan data transmission unit 162 has automatically transmitted the scan data to the automatic transmission destination set by the transmission destination setting unit 155. In the present exemplary embodiment, this processing in the notification unit 160 is performed as an example of performing processing for saving data in an alternative saving destination when the failure has not been solved by the termination time of confirming that the failure has been solved. In addition, in the present exemplary embodiment, this processing of the notification unit 160 is performed as an example of notifying the user that the data has been saved when the failure has not been resolved by the termination time of confirming that the failure has been solved. Further, in the present exemplary embodiment, this processing of the notification unit 160 is performed as an example of performing processing for saving the image data in an alternative saving destination when the failure has not been solved by the time at which the user is notified that the saving deadline of the image data set as the termination time is approaching.

The upload unit 161 is the same as the upload unit 111 in the first exemplary embodiment, and a description thereof will be omitted.

The scan data transmission unit 162 automatically transmits the scan data when the upload deadline notification date has reached without availability of connection with the cloud service being confirmed after the execution of the prior scan. Specifically, the scan data transmission unit 162 takes out the scan data from the scan data storage unit 153, and automatically transmits the scan data to the automatic transmission destination set by the transmission destination setting unit 155. In the present exemplary embodiment, this processing in the scan data transmission unit 162 is performed as an example of performing processing for saving data in an alternative saving destination when the failure has not been solved by the termination time of confirming that the failure has been solved. In the present exemplary embodiment, this processing in the scan data transmission unit 162 is performed as an example of saving data in an alternative saving destination by a predetermined method when the failure has not been solved by the termination time of confirming that the failure has been solved. Further, in the present exemplary embodiment, this processing of the scan data transmission unit 162 is performed as an example of performing processing for saving the image data in an alternative saving destination when the failure has not been solved by the time at which the user is notified that the saving deadline of the image data set as the termination time is approaching.

### (Operation of Image Processing Apparatus)

An operation example of the image processing apparatus 10 according to the second exemplary embodiment at the start of use of the cloud service is substantially the same as the operation example illustrated in the flowchart of FIG. 13. However, in the example of the operation of the image processing apparatus 10 according to the second exemplary embodiment at the start of use of the cloud service, after step 206 in the flowchart of FIG. 13, the transmission destination setting unit 155 sets an automatic transmission destination to which scan data is automatically transmitted.

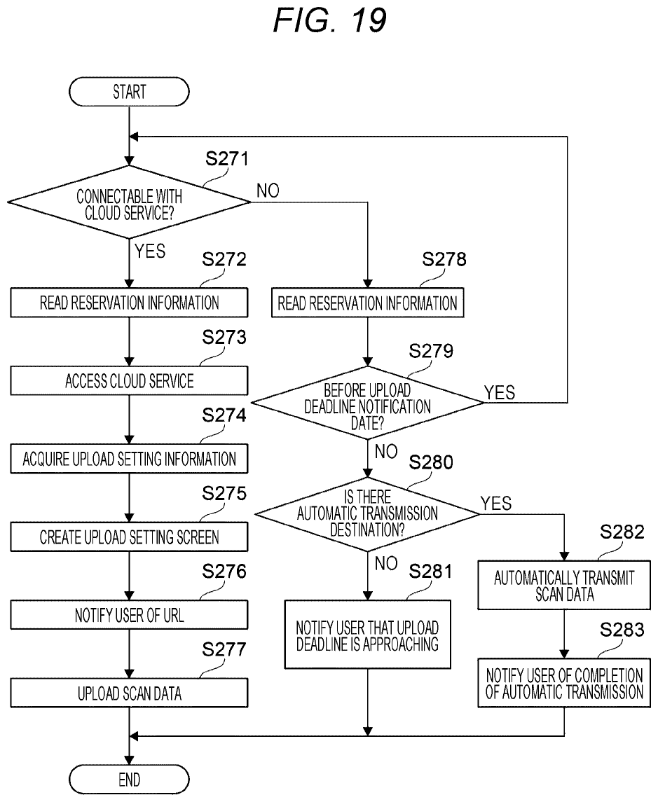

FIG. 19 is a flowchart illustrating an operation example of the image processing apparatus 10 according to the second exemplary embodiment after an execution of the prior scan.

In the image processing apparatus 10, first, the cloud service connection checking unit 151 checks whether connection with the cloud service is possible (step 271).

When it has been confirmed in step 271 that connection with the cloud service is possible, the processing in steps 272 to 277 are performed. Here, processing in steps 272 to 277 is the same as the processing in steps 222 to 227 in FIG. 14, and therefore, description thereof is omitted.

On the other hand, when it has not been confirmed in step 271 that the connection with the cloud service is possible, the reservation information management unit 156 reads the reservation information from the reservation information storage unit 157 (step 278). Next, the reservation information management unit 156 determines whether the current date is earlier than the upload deadline notification date included in the reservation information read in step 278 (step 279).

When it has been determined in step 279 that the current date is earlier than the upload deadline notification date, the reservation information management unit 156 returns the processing to step 271.

On the other hand, when it has been determined in step 279 that the current date is not earlier than the upload deadline notification date, the reservation information management unit 156 determines whether the reservation information read in step 278 includes an automatic transmission destination (step 280).

When it has been determined in step 280 that the reservation information does not include an automatic transmission destination, the notification unit 160 notifies the user that the upload deadline is approaching, for example, by E-mail (step 281). This E-mail may include a description on an alternative method with respect to uploading of the scan data to the cloud service selected by the user.

On the other hand, when it has been determined in step 280 that the automatic transmission destination is included in the reservation information, the scan data transmission unit 162 automatically transmits the scan data stored in the scan data storage unit 153 to the automatic transmission destination included in the reservation information (step 282). Here, the automatic transmission of the scan data to the automatic transmission destination may be performed by an alternative method with respect to the uploading of the scan data to the cloud service selected by the user. After that, the notification unit 160 notifies the user that the automatic transmission of the scan data has been completed by, for example, E-mail (step 283).

### [Processor]

In the present exemplary embodiment, the processor refers to a processor in a broad sense, and includes general-purpose processors (for example, CPU: central processing unit) and dedicated processors (for example, GPU: graphics processing unit, ASIC: application specific integrated circuit, FPGA: field programmable gate array, and programmable logic devices).

The operation of the processor in the present exemplary embodiment may be performed not only by one processor but also by a plurality of processors existing at physically distant positions in cooperation with each other. In addition, the order of the operations of the processor is not limited to the order described in the present exemplary embodiment, and may be changed.

### [Program]

The processing performed by the image processing apparatus 10 according to the present exemplary embodiment is prepared as, for example, a program such as application software.

In this case, the program that realizes the present exemplary embodiment is regarded as a program for causing a computer to execute: a function of, when a failure has occurred in a connection with a cloud service and a user has given an instruction to save data in the cloud service, saving the data in an apparatus other than the cloud service; and a function of, after the failure has been solved, using saving destination information indicating at least one saving destination held by the cloud service, performing processing for saving the data in any of the at least one saving destination of the cloud service.

The program that realizes the exemplary embodiment can be provided not only by a communication method but also by being stored in a recording medium such as a CD-ROM.

### [Supplementary Note] (((1)))

An information processing system comprising at least one processor,
wherein when a failure has occurred in a connection with a cloud service and a user has given an instruction to save data in the cloud service, the at least one processor saves the data in an apparatus other than the cloud service, and after the failure has been solved, using saving destination information indicating at least one saving destination held by the cloud service, the at least one processor performs processing for saving the data in any of the at least one saving destination of the cloud service.
   (((2)))

The information processing system according to (((1))), wherein
the processing for saving the data in any of the at least one saving destination of the cloud service using the saving destination information is processing for notifying the user of the saving destination information and saving the data in a saving destination designated by the user among the at least one saving destination indicated by the saving destination information.
   (((3)))

The information processing system according to (((2))), wherein
when the failure has occurred and the user has given an instruction to save the data in the cloud service, the art least one processor saves the data in association with identification information of the user, and after the failure has been solved, the at least one processor accesses the cloud service using the identification information to acquire the saving destination information.
   (((4)))

The information processing system according to any one of (((1)) to ((3))), wherein
when the failure has occurred and the user has given an instruction to save, in the cloud service, image data obtained by reading a document with an image reading unit as the data, the at least one processor performs processing for instructing the user to read the document with the image reading unit, saving, in an apparatus other than the cloud service, the image data obtained by the user reading the document with the image reading unit, and saving, in any of the at least one saving destination in the cloud service, the image data using the saving destination information after the failure has been solved.
   (((5)))

The information processing system according to (((1))), wherein
the at least one processor performs processing for saving the data in an alternative saving destination when the failure has not been solved by a termination time of confirming that the failure has been solved.
   (((6)))

The information processing system according to (((5))), wherein
the at least one processor sets the termination time when the failure has occurred and the user has given an instruction to save the data in the cloud service.
   (((7)))

The information processing system according to (((5))), wherein
the processing for saving the data in the alternative saving destination is processing for notifying the user of an operation that the user can perform to save the data in the alternative saving destination.
   (((8)))

The information processing system according to (((5))), wherein
the processing for saving the data in the alternative saving destination is processing for saving the data in the alternative saving destination by a predetermined method and notifying the user that the data has been saved.
   (((9)))

The information processing system according to any one of (((5)) to ((8))), wherein
when the failure has occurred and the user has given an instruction to save, in the cloud service, image data obtained by reading a document with an image reading unit as the data, the at least one processor performs processing for saving, in an apparatus other than the cloud service, the image data obtained by the user reading the document with the image reading unit, and saving the image date in the alternative saving destination when the failure has not been solved by a time for notifying the user that a saving deadline of the image date set as the termination time is approaching.
   (((10)))

A non-transitory computer-readable storage medium storing a program for causing a computer to execute:
a function of, when a failure has occurred in a connection with a cloud service and a user has given an instruction to save data in the cloud service, saving the data in an apparatus other than the cloud service; and
a function of, after the failure has been solved, using saving destination information indicating at least one saving destination held by the cloud service, performing processing for saving the data in any of the at least one saving destination of the cloud service.

What is claimed is:

1. An information processing system comprising at least one processor,
wherein when a failure has occurred in a connection with a cloud service and a user has given an instruction to save data in the cloud service, the at least one processor saves the data in an apparatus other than the cloud service, and after the failure has been solved, using saving destination information indicating at least one saving destination held by the cloud service, the at least one processor performs processing for saving the data in any of the at least one saving destination of the cloud service.

2. The information processing system according to claim 1, wherein
the processing for saving the data in any of the at least one saving destination of the cloud service using the saving destination information is processing for notifying the user of the saving destination information and saving the data in a saving destination designated by the user among the at least one saving destination indicated by the saving destination information.

3. The information processing system according to claim 2, wherein
when the failure has occurred and the user has given an instruction to save the data in the cloud service, the at least one processor saves the data in association with identification information of the user, and after the failure has been solved, the at least one processor accesses the cloud service using the identification information to acquire the saving destination information.

4. The information processing system according to claim 1, wherein
when the failure has occurred and the user has given an instruction to save, in the cloud service, image data obtained by reading a document with an image reading unit as the data, the at least one processor performs processing for instructing the user to read the document with the image reading unit, saving, in an apparatus other than the cloud service, the image data obtained by the user reading the document with the image reading unit, and saving, in any of the at least one saving destination in the cloud service, the image data using the saving destination information after the failure has been solved.

5. The information processing system according to claim 2, wherein
when the failure has occurred and the user has given an instruction to save, in the cloud service, image data obtained by reading a document with an image reading unit as the data, the at least one processor performs processing for instructing the user to read the document with the image reading unit, saving, in an apparatus other than the cloud service, the image data obtained by the user reading the document with the image reading unit, and saving, in any of the at least one saving destination in the cloud service, the image data using the saving destination information after the failure has been solved.

6. The information processing system according to claim 3, wherein
when the failure has occurred and the user has given an instruction to save, in the cloud service, image data obtained by reading a document with an image reading unit as the data, the at least one processor performs processing for instructing the user to read the document with the image reading unit, saving, in an apparatus other than the cloud service, the image data obtained by the user reading the document with the image reading unit, and saving, in any of the at least one saving destination in the cloud service, the image data using the saving destination information after the failure has been solved.

7. The information processing system according to claim 1, wherein
the at least one processor performs processing for saving the data in an alternative saving destination when the failure has not been solved by a termination time of confirming that the failure has been solved.

8. The information processing system according to claim 7, wherein
the at least one processor sets the termination time when the failure has occurred and the user has given an instruction to save the data in the cloud service.

9. The information processing system according to claim 7, wherein
the processing for saving the data in the alternative saving destination is processing for notifying the user of an operation that the user can perform to save the data in the alternative saving destination.

10. The information processing system according to claim 7, wherein
the processing for saving the data in the alternative saving destination is processing for saving the data in the alternative saving destination by a predetermined method and notifying the user that the data has been saved.

11. The information processing system according to claim 7, wherein
when the failure has occurred and the user has given an instruction to save, in the cloud service, image data obtained by reading a document with an image reading unit as the data, the at least one processor performs processing for saving, in an apparatus other than the cloud service, the image data obtained by the user reading the document with the image reading unit, and saving the image date in the alternative saving destination when the failure has not been solved by a time for notifying the user that a saving deadline of the image date set as the termination time is approaching.

12. The information processing system according to claim 8, wherein
when the failure has occurred and the user has given an instruction to save, in the cloud service, image data obtained by reading a document with an image reading unit as the data, the at least one processor performs processing for saving, in an apparatus other than the cloud service, the image data obtained by the user reading the document with the image reading unit, and saving the image date in the alternative saving destination when the failure has not been solved by a time for notifying the user that a saving deadline of the image date set as the termination time is approaching.

13. The information processing system according to claim 9, wherein
when the failure has occurred and the user has given an instruction to save, in the cloud service, image data obtained by reading a document with an image reading unit as the data, the at least one processor performs processing for saving, in an apparatus other than the cloud service, the image data obtained by the user reading the document with the image reading unit, and saving the image date in the alternative saving destination when the failure has not been solved by a time for notifying the user that a saving deadline of the image date set as the termination time is approaching.

14. The information processing system according to claim 10, wherein
when the failure has occurred and the user has given an instruction to save, in the cloud service, image data obtained by reading a document with an image reading unit as the data, the at least one processor performs processing for saving, in an apparatus other than the cloud service, the image data obtained by the user reading the document with the image reading unit, and saving the image date in the alternative saving destination when the failure has not been solved by a time for notifying the user that a saving deadline of the image date set as the termination time is approaching.

15. A non-transitory computer-readable storage medium storing a program for causing a computer to execute:
a function of, when a failure has occurred in a connection with a cloud service and a user has given an instruction to save data in the cloud service, saving the data in an apparatus other than the cloud service; and
a function of, after the failure has been solved, using saving destination information indicating at least one saving destination held by the cloud service, performing processing for saving the data in any of the at least one saving destination of the cloud service.
